(19) United States
(12) Patent Application Publication
(10) Pub. No.: US 2026/0008548 A1
(43) Pub. Date: Jan. 8, 2026

(54) ICE PROTECTION CONNECTED TO ALTERNATING CURRENT (AC)-GENERATED OUTPUT FOR HIGH-VOLTAGE DIRECT CURRENT (DC) AIRCRAFT SYSTEM

(71) Applicant: Hamilton Sundstrand Corporation, Charlotte, NC (US)

(72) Inventors: Kyle Ives, Loves Park, IL (US); Alex Gomes, Chicago, IL (US); Andrew K. Taylor, Hudson, OH (US); Galdemir C. Botura, Copley, OH (US); Matthew Davis, Canton, OH (US); Michael J. Krenz, Roscoe, IL (US)

(21) Appl. No.: 18/762,477

(22) Filed: Jul. 2, 2024

(51) Int. Cl. B64D 15/12; H05B 3/22

(52) U.S. Cl. CPC B64D 15/12; H05B 3/22

(57) ABSTRACT

An apparatus may include a generator, an electrical converter, and multiple ice protection heaters. The generator may be configured to generate alternating current (AC) along AC feeders. The electrical converter may be configured to convert the AC from the generator to direct current (DC). The ice protection heaters may include at least one ice protection heater connected to each of the AC feeders prior to the electrical converter. The ice protection heaters may be configured to generate heat at surfaces susceptible to icing using the AC from the generator.

### TECHNICAL FIELD

This disclosure relates generally to aircraft devices and processes. More specifically, this disclosure relates to ice protection connected to an alternating current (AC)-generated output for a high-voltage direct current (DC) aircraft system.

### BACKGROUND

A thermal aircraft ice protection system provides heat to select locations on an aircraft in order to prevent ice accumulation or to melt ice that has accumulated. Historically, the majority of jet aircraft ice protection systems have used hot bleed air from an aircraft's engines to provide this heat.

### SUMMARY

This disclosure provides ice protection connected to an alternating current (AC)-generated output for a high-voltage direct current (DC) aircraft system.

In some examples, an apparatus may include a generator, an electrical converter, and multiple ice protection heaters. The generator may be configured to generate AC along AC feeders. The electrical converter may be configured to convert the AC from the generator to DC. The ice protection heaters may include at least one ice protection heater connected to each of the AC feeders prior to the electrical converter. The ice protection heaters may be configured to generate heat at surfaces susceptible to icing using the AC from the generator.

Any single one or any combination of the following features may be used with the above example. The apparatus may include multiple ice protection control switches, including at least one ice protection control switch positioned between the at least one ice protection heater and the at least one corresponding AC feeder. The ice protection control switches may be configured to control the AC to the at least one ice protection heater. The ice protection heaters may be coupled to the AC feeders upstream from a primary electrical converter. The at least one ice protection heater connected to each of the AC feeders may include multiple ice protection heaters connected in parallel to one of the AC feeders. The ice protection heaters may be arranged in a wye arrangement. The ice protection heaters may be arranged in a delta arrangement.

In other examples, an ice protection system may include a generator, an electrical converter, a high-voltage DC bus, and multiple ice protection heaters. The generator is configured to generate AC along AC feeders. The electrical converter may be configured to convert the AC from the generator to DC. The high-voltage DC bus may be configured to direct the DC to one or more aircraft loads. The ice protection heaters may include at least one ice protection heater connected to each of the AC feeders prior to the electrical converter. The ice protection heaters may be configured to generate heat at surfaces susceptible to icing using the AC from the generator.

Any single one or any combination of the following features may be used with the above example. The ice protection system may include multiple ice protection control switches, including at least one ice protection control switch positioned between the at least one ice protection heater and the at least one corresponding AC feeder. The ice protection control switches may be configured to control the AC to the at least one ice protection heater. The ice protection heaters may be coupled to the AC feeders upstream from a primary electrical converter. The at least one ice protection heater connected to each of the AC feeders may include multiple ice protection heaters connected in parallel to one of the AC feeders. The ice protection heaters may be arranged in a wye arrangement. The ice protection heaters may be arranged in a delta arrangement.

In still other examples, a method may include generating, using a generator, AC along AC feeders. The method also may include converting, using an electrical converter, the AC from the generator to DC. The method may further include generating, using multiple ice protection heaters including at least one ice protection heater connected to each of the AC feeders prior to the electrical converter, heat at surfaces susceptible to icing using the AC from the generator.

Any single one or any combination of the following features may be used with the above example. The method may include controlling, using multiple ice protection control switches including at least one ice protection control switch positioned between the at least one ice protection heater and the at least one corresponding AC feeder, the AC to the at least one ice protection heater. The ice protection heaters may be coupled to the AC feeders upstream from a primary electrical converter. The at least one ice protection heater connected to each of the AC feeders may include multiple ice protection heaters connected in parallel to one of the AC feeders. The ice protection heaters may be arranged in a wye arrangement. The ice protection heaters may be arranged in a delta arrangement.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A and 1B illustrate example architectures for electrothermal ice protection systems in accordance with this disclosure; and

FIG. 2 illustrates an example method for ice protection connected to alternating current (AC)-generated output for a high-voltage direct current (DC) aircraft system according to this disclosure.

### DETAILED DESCRIPTION

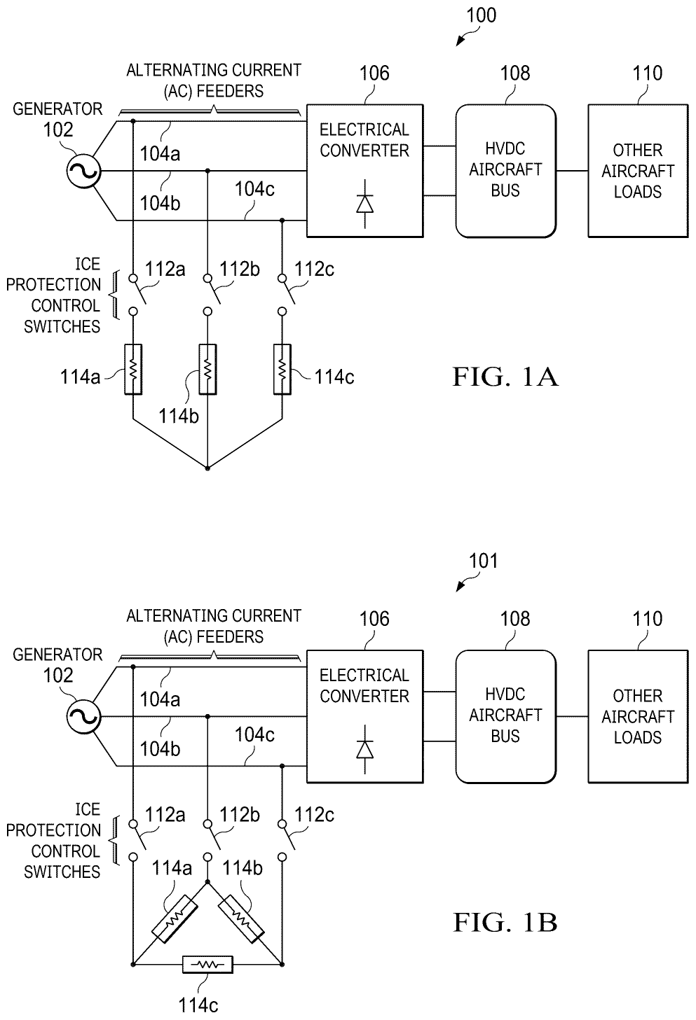

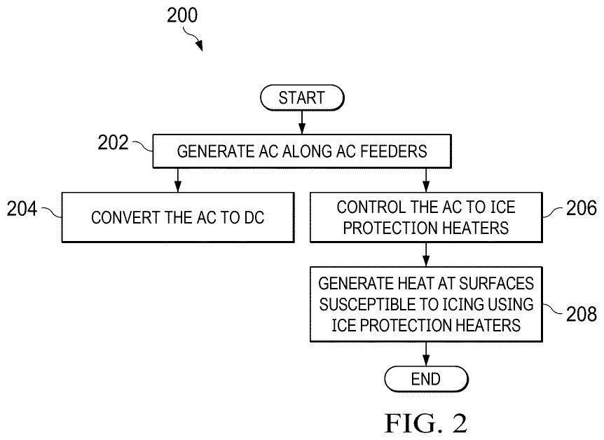

FIGS. 1A through 2, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, a thermal aircraft ice protection system provides heat to select locations on an aircraft in order to prevent ice accumulation or to melt ice that has accumulated. Historically, the majority of jet aircraft ice protection systems have used hot bleed air from an aircraft's engines to provide this heat. Alternatively, electricity may be used to provide the heat for preventing ice accumulation. Like hot bleed air based systems, using electricity for heating requires a large amount of energy to properly generate heat for preventing ice accumulation. The efficiency of the energy transfer from a source, such as a generator, to load locations, such as ice protection zones, becomes a key enabling factor for electrical ice protection of larger areas. Because power equals voltage times current, higher voltages can be used to reduce current. However, the current is a governor of loss as power is also equal to current squared times resistance. Any power conversion, such as rectification, also results in energy loss. This disclosure provides for positioning electrical loads relative to a generator and for improving power conversion and power switching.

FIGS. 1A and 1B illustrate example architectures for electrothermal ice protection systems 100 and 101 in accordance with this disclosure. As shown in FIGS. 1A and 1B, the electrothermal ice protection systems 100 and 101 can use aircraft electrical power to perform ice protection functions, such as de-ice and anti-ice, on critical surfaces where ice accumulation may impact continued safe flight and landing, such as aircraft flight surfaces, engine nacelle, propellers, etc.

The electrothermal ice protection systems 100 and 101 include a generator 102. Three alternating current (AC) feeders 104a through 104c are connected for feeding AC output from the generator 102. An electrical converter 106 is electrically connected to the three AC feeders 104a through 104c. The electrical converter 106 is configured to convert three phase AC from the three AC feeders 104a through 104c of the generator 102 into direct current (DC) output through a high voltage DC (HVDC) aircraft bus 108. The electrical converter 106 can be run through one or more pieces of electrical conversion equipment with 90-95% efficiency, leading to power loss. The HVDC aircraft bus 108 is connected to various aircraft electric systems 110 and provides operational electric power to the aircraft electric systems 110.

At least one ice protection control switch 112a through 112c is connected to each of the AC feeders 104a through 104c to eliminate unnecessary power conversion prior to the load. The ice protection control switches 112a through 112c respond to commands from a controller and control power supply to the ice protection heaters 114a through 114c. In one example, the ice protection control switches 112a through 112c comprise a field effect transistor (FET). Other examples include solid state switches such as insulated gate bipolar transistors, bipolar transistors, silicon-controlled rectifiers (SCR) and triac switches within a full wave bridge rectifier. The particular type of ice protection control switch 112a through 112c selected can depend upon the needs of a particular situation. As non-limiting examples, the ice protection control switches 112a through 112c can be arranged in a wye connection shown in FIG. 1A and a delta connection shown in FIG. 1B.

The ice protection heaters 114a through 114c can be purely resistive loads. The ice protection heaters 114a through 114c can be placed upstream of a primary power converter and do not suffer from adverse impact from AC voltage distortion. Because the ice protection heaters 114a through 114c no longer flow through a converter (and other downstream electrical equipment), the electrical converter 106 can be 30%-50% smaller, lighter, and more reliable. The ice protection heaters 114a through 114c can be powered more efficiently as the electricity is not flowing through one or more conversion devices. The arrangement of the ice protection heaters 114a through 114c also improves reliability of ice protection systems due to reducing a number of components. For example, less wiring is required because the connection of the ice protection control switches 112a through 112c to the AC feeders 104a through 104c is more direct than from the HVDC aircraft bus 108 located in a main body of the aircraft. The arrangement of ice protection heaters 114a through 114c is also less prone to issues associated with uncontrolled over voltage (OV) from the generators. The ice protection heaters 114a through 114c can absorb the higher voltage for some time, while a failed generator is shut-down.

The ice protection heaters 114a through 114c can comprise a material having a predetermined temperature coefficient of resistivity that provides a predictable relationship between heater temperature and heater resistance. The coefficient of resistivity of the heater material is used to monitor the average change in temperature of the ice protection heaters 114a through 114c.

The ice protections heaters 114a through 114c can be controlled based on the opening and closing of the respective ice protection control switches 112a through 112c. As non-limiting examples, heater on and off times for the ice protection heaters 114a through 114c can be calculated as a function of the ambient temperature and the airspeed. A heater timing cycle, generally speaking, includes a heater on time and a heater off time, the sum of which defines one complete cycle.

Although FIGS. 1A and 1B illustrate example architectures for electrothermal ice protection systems 100 and 101, various changes may be made to FIGS. 1A and 1B. For example, various components in FIGS. 1A and 1B may be combined, further subdivided, replicated, omitted, or rearranged and additional components may be added according to particular needs. In particular, multiple ice protection heaters 114a through 114c can be connected to each of the AC feeders 104a through 104c. This would also allow for an ice protection system where a first set of ice protection heaters 114a through 114c is arranged in the wye connection and a second set of ice protection heaters 114a through 114 is arranged in the delta connection.

FIG. 2 illustrates an example method 200 for ice protection connected to AC-generated output for a high-voltage DC aircraft system according to this disclosure. For case of explanation, the method 200 of FIG. 2 is described as being performed using the electrothermal ice protection system 100 of FIG. 1A. However, the method 200 may be used with any other suitable system and any other suitable electrothermal ice protection system.

As shown in FIG. 2, the electrothermal ice protection system 100 generates AC along AC feeders at step 202. The AC current is generated along AC feeders from a generator 102. The electrothermal ice protection system 100 converts the AC to DC at step 204. The AC from the generator 102 is converted to DC using an electrical converter 106. The DC is provided to an HVDC aircraft bus 108, which distributes the DC to other aircraft electric systems 110.

The electrothermal ice protection system 100 controls the AC to the ice protection heaters 114a through 114c at step 206. The provision of the AC to the at least one ice protection heater 114a through 114c is controlled using multiple ice protection control switches 112a through 112c including an ice protection control switch 112a through 112c positioned between an AC feeder 104a through 104c and the at least one ice protection heater 114a through 114c.

The electrothermal ice protection system 100 generates heat at surfaces susceptible to icing using ice protection heaters 114a through 114c at step 208. The heat is generated at surfaces susceptible to icing using the AC from the generator 102 using multiple ice protection heaters 114a through 114c. At least one ice protection heater 114a through 114c is connected to each of the AC feeders 104a through 104c prior to the electrical converter 106. The ice protection heaters 114a through 114c can be coupled to the AC feeders 104a through 104c upstream from a primary electrical converter 106. The at least one ice protection heater 114a through 114c connected to each of the AC feeders 104a through 104c includes multiple protection heaters 114a through 114c connected in parallel to one of the AC feeders 104a through 104c. The ice protection heaters 114a through 114c can be arranged in at least one of a wye arrangement and a delta arrangement.

Although FIG. 2 illustrates an example method 200 for ice protection connected to AC-generated output for a high-voltage DC aircraft system, various changes may be made to FIG. 2. For example, while shown as a series of steps, various steps in FIG. 2 may overlap, occur in parallel, or occur any number of times.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a generator configured to generate alternating current (AC) along AC feeders;
an electrical converter configured to convert the AC from the generator to direct current (DC); and
multiple ice protection heaters including at least one ice protection heater connected to each of the AC feeders prior to the electrical converter, the ice protection heaters configured to generate heat at surfaces susceptible to icing using the AC from the generator.

2. The apparatus of claim 1, further comprising:
multiple ice protection control switches, including at least one ice protection control switch positioned between the at least one ice protection heater and the at least one corresponding AC feeder.

3. The apparatus of claim 2, wherein the ice protection control switches are configured to control the AC to the at least one ice protection heater.

4. The apparatus of claim 1, wherein the ice protection heaters are coupled to the AC feeders upstream from a primary electrical converter.

5. The apparatus of claim 1, wherein the at least one ice protection heater connected to each of the AC feeders includes multiple ice protection heaters connected in parallel to one of the AC feeders.

6. The apparatus of claim 1, wherein the ice protection heaters are arranged in a wye arrangement.

7. The apparatus of claim 1, wherein the ice protection heaters are arranged in a delta arrangement.

8. An ice protection system comprising:
a generator configured to generate alternating current (AC) along AC feeders;
an electrical converter configured to convert the AC from the generator to direct current (DC);
a high-voltage DC bus configured to direct the DC to one or more aircraft loads; and
multiple ice protection heaters including at least one ice protection heater connected to each of the AC feeders prior to the electrical converter, the ice protection heaters configured to generate heat at surfaces susceptible to icing using the AC from the generator.

9. The ice protection system of claim 8, further comprising:
multiple ice protection control switches, including at least one ice protection control switch positioned between the at least one ice protection heater and the at least one corresponding AC feeder.

10. The ice protection system of claim 9, wherein the ice protection control switches are configured to control the AC to the at least one ice protection heater.

11. The ice protection system of claim 8, wherein the ice protection heaters are coupled to the AC feeders upstream from a primary electrical converter.

12. The ice protection system of claim 8, wherein the at least one ice protection heater connected to each of the AC feeders includes multiple ice protection heaters connected in parallel to one of the AC feeders.

13. The ice protection system of claim 8, wherein the ice protection heaters are arranged in a wye arrangement.

14. The ice protection system of claim 8, wherein the ice protection heaters are arranged in a delta arrangement.

15. A method comprising:
generating, using a generator, alternating current (AC) along AC feeders;
converting, using an electrical converter, the AC from the generator to direct current (DC); and
generating, using multiple ice protection heaters including at least one ice protection heater connected to each of the AC feeders prior to the electrical converter, heat at surfaces susceptible to icing using the AC from the generator.

16. The method of claim 15, further comprising:
controlling, using multiple ice protection control switches including at least one ice protection control switch positioned between the at least one ice protection heater and the at least one corresponding AC feeder, the AC to the at least one ice protection heater.

17. The method of claim 15, wherein the ice protection heaters are coupled to the AC feeders upstream from a primary electrical converter.

18. The method of claim 15, wherein the at least one ice protection heater connected to each of the AC feeders includes multiple ice protection heaters connected in parallel to one of the AC feeders.

19. The method of claim 15, wherein the ice protection heaters are arranged in a wye arrangement.

20. The method of claim 15, wherein the ice protection heaters are arranged in a delta arrangement.
